(19) United States
(12) Patent Application Publication
(10) Pub. No.: US 2018/0279091 A1
(43) Pub. Date: Sep. 27, 2018

(54) Wireless Earpieces Utilizing a Mesh Network

(71) Applicant: BRAGI GmbH, Munchen (DE)

(72) Inventors: Peter Vincent Boesen, Munchen (DE); Darko Dragicevic, Munchen (DE)

(73) Assignee: BRAGI GmbH, München (DE)

(21) Appl. No.: 15/905,322

(22) Filed: Feb. 26, 2018

Related U.S. Application Data
(60) Provisional application No. 62/475,038, filed on Mar. 22, 2017.

(51) Int. Cl. H04W 4/12; H04R 1/10; H04W 76/10; H04W 12/06

(52) U.S. Cl. CPC H04W 4/12; H04R 1/1091; H04W 84/18; H04W 12/06; H04R 2420/07; H04W 76/10

(57) ABSTRACT

A method of utilizing a mesh network utilizing wireless earpieces in an embodiment of the present invention may have one or more of the following steps: (a) receiving a communication to be sent through the wireless earpieces, (b) connecting to one or more devices representing a node in a mesh network, (c) sending the communication to the one more devices to reach a receiving party through the mesh network, (d) receiving a confirmation of receipt of the communication by the receiving party in response to the receiving party receiving the communication, (e) receiving communications through the mesh network at the wireless earpieces from the one or more devices, and (f) expanding the mesh network to include another device in response to the wireless earpieces or the one or more devices detecting another device is available for mesh communications.

### PRIORITY STATEMENT

This application claims priority to U.S. Provisional Patent Application No. 62/475,038 filed on Mar. 22, 2017 titled Wireless Earpieces Utilizing a Mesh Network all of which is hereby incorporated by reference in its entirety.

### FIELD OF THE INVENTION

The illustrative embodiments relate to wearable devices. Particularly, embodiments of the present invention relate to wireless earpieces. More particularly, but not exclusively, the illustrative embodiments relate to wireless earpieces utilizing a mesh network for communications.

### BACKGROUND

A mesh network is a local network topology in which the infrastructure nodes (i.e., bridges, switches and other infrastructure devices) connect directly, dynamically and non-hierarchically to as many other nodes as possible and cooperate with one another to efficiently route data from/to clients. This lack of dependency on one node allows for every node to participate in the relay of information. Mesh networks dynamically self-organize and self-configure, which can reduce installation overhead. The ability to self-configure enables dynamic distribution of workloads, particularly in the event a few nodes should fail. This in turn contributes to fault-tolerance and reduced maintenance costs.

Mesh topology may be contrasted with conventional star/tree local network topologies in which the bridges/switches are directly linked to only a small subset of other bridges/switches, and the links between these infrastructure neighbors are hierarchical. While star-and-tree topologies are very well established, highly standardized and vendor-neutral, vendors of mesh network devices have not yet all agreed on common standards, and interoperability between devices from different vendors is not yet assured.

Wireless mesh radio networks were originally developed for military applications, so every node could dynamically serve as a router for every other node. Even in the event of a failure of some nodes, the remaining nodes could continue to communicate with each other, and, if necessary, to serve as uplinks for the other nodes.

Early wireless mesh network nodes had a single half-duplex radio, at any one instant, transmitting or receiving, but not both at the same time. This was accompanied by the development of shared mesh networks. This was subsequently superseded by more complex radio hardware receiving packets from an upstream node and transmitting packets to a downstream node simultaneously (on a different frequency or a different CDMA (Code Division Multiple Access channel)). This allowed the development of switched mesh networks. As the size, cost, and power requirements of radios declined further, nodes could be cost-effectively equipped with multiple radios. This in turn permitted each radio to handle a different function, for instance one radio for client access, and another for backhaul services. Work in this field has been aided using game theory methods to analyze strategies for the allocation of resources and routing of packets.

Mesh networks can relay messages using either a flooding technique or a routing technique. With routing, the message is propagated along a path by hopping from node to node until it reaches its destination. To ensure all its paths are available, the network must allow for continuous connections and must reconfigure itself around broken paths, using self-healing algorithms such as Shortest Path Bridging. Self-healing allows a routing-based network to operate when a node breaks down or when a connection becomes unreliable. As a result, the network is typically quite reliable, as there is often more than one path between a source and a destination in the network. Although mostly used in wireless situations, this concept can also apply to wired networks and to software interaction.

A mesh network whose nodes are all connected to each other is a fully connected network. Fully connected wired networks have the advantages of security and reliability: problems in a cable affect only the two nodes attached to it. However, in such networks, the number of cables, and therefore the cost, goes up rapidly as the number of nodes increases.

Wireless earpieces are a new class of consumer electronic devices with excellent growth potential. Wireless earpieces have focused on personal entertainment and communications. For example, wireless earpieces may be utilized with a cellular phone to make phone calls. Thus far, wireless devices have not efficiently facilitated communications between multiple potential users or when communications signals, connections, or links are not available.

### SUMMARY

Therefore, it is a primary object, feature, or advantage of the present invention to improve over the state of the art.

A method of utilizing a mesh network utilizing wireless earpieces in an embodiment of the present invention may have one or more of the following steps: (a) receiving a communication to be sent through the wireless earpieces, (b) connecting to one or more devices representing a node in a mesh network, (c) sending the communication to the one more devices to reach a receiving party through the mesh network, (d) receiving a confirmation of receipt of the communication by the receiving party in response to the receiving party receiving the communication, (e) receiving communications through the mesh network at the wireless earpieces from the one or more devices, and (f) expanding the mesh network to include another device in response to the wireless earpieces or the one or more devices detecting another device is available for mesh communications.

A wireless earpiece in embodiments of the present invention may have one or more of the following features: (a) a housing for fitting in an ear of a user, (b) a logic engine controlling functionality of the wireless earpiece, (c) a plurality of sensors performing sensor measurements of the user and an environment of the user, and (d) a transceiver searching for one or more devices able to communicate as part of a mesh network with the transceiver, and establishing a wireless connection between the transceiver and one of the one or more devices wherein the logic engine sends communications through the transceiver to the one or more devices available through the mesh network for communication to a receiving party.

A wireless earpiece in an embodiment of the present invention may have one or more of the following features: (a) a housing for fitting in an ear of a user, (b) a processor controlling functionality of the wireless earpiece, (c) a plurality of sensors read user input from the user, and (d) a transceiver communicating with a mesh Internet of Things (IoT) network wherein the processor associates the wireless earpieces with the mesh IoT, receives user input from a user wearing the wireless earpieces, and sends a communication for a peripheral within the mesh IoT to perform the command from the wireless earpieces or from a second peripheral linked with the wireless earpieces.

One or more of these and/or other objects, features, or advantages of the present invention will become apparent from the specification and claims follow. No single embodiment need provide every object, feature, or advantage. Different embodiments may have different objects, features, or advantages. Therefore, the present invention is not to be limited to or by any object, feature, or advantage stated herein.

### BRIEF DESCRIPTION OF THE DRAWINGS

FIG. 1 illustrates a pictorial representation of a mesh network in accordance with an illustrative embodiment;

FIG. 2 illustrates a right wireless earpiece of a wireless earpiece set as it relates to a user's right ear in accordance with an illustrative embodiment;

FIG. 3 is a block diagram of a wireless earpiece system in accordance with an illustrative embodiment;

FIG. 4 is a flowchart of a process for performing communications through a mesh network utilizing wireless earpieces in accordance with an illustrative embodiment;

FIG. 5 is a flowchart of another process for performing communications through a mesh network utilizing wireless earpieces in accordance with an illustrative embodiment;

FIG. 6 is a pictorial representation of a communications environment in accordance with an illustrative embodiment;

FIG. 7 is a pictorial representation of a computing system in accordance with an illustrative embodiment; and

FIG. 8 illustrates a wireless earpiece with a mesh network for control of an IoT in an illustrative embodiment.

Some of the figures include graphical and ornamental elements. It is to be understood the illustrative embodiments contemplate all permutations and combinations of the various graphical elements set forth in the figures thereof.

### DETAILED DESCRIPTION

The following discussion is presented to enable a person skilled in the art to make and use the present teachings. Various modifications to the illustrated embodiments will be clear to those skilled in the art, and the generic principles herein may be applied to other embodiments and applications without departing from the present teachings. Thus, the present teachings are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the present invention are discussed in terms of wearable electronic devices, it is fully contemplated embodiments of the present invention could be used in most any mesh networking system without departing from the spirit of the invention.

One embodiment provides a system, method and wireless earpieces for utilizing a mesh network. A communication is received to be sent through the wireless earpieces. One or more devices represent a node in a mesh network. The communication is sent to the one or more devices to reach a receiving party through the mesh network. Another embodiment provides wireless earpieces including a processor and a memory storing a set of instructions. The set of instructions are executed to perform the method described above.

Another embodiment provides a wireless earpiece. The wireless earpiece may include a housing for fitting in an ear of a user. The wireless earpiece may also include a logic engine controlling functionality of the wireless earpiece. The wireless earpiece may also include several sensors performing sensor measurements of the user and an environment of the user. The wireless earpiece may also include a transceiver searching for one or more devices able to communicate as part of a mesh network with the transceiver and establishes a wireless connection between the transceiver and one of the one or more devices. The logic engine sends communications through the transceiver to the one or more devices available through the mesh network for communication to a receiving party.

The illustrative embodiments provide a system, method and wireless earpieces for performing communications utilizing a mesh network. In one embodiment, the wireless earpieces may be utilized to directly or indirectly communicate discrete or real-time communications to other wireless earpieces or electronic devices. Hardware, logic and operating system, a kernel, or an application executed by the wireless earpieces or an associated wireless device may control the communications including any confirmations, responses, or authorizations required to perform the initial or ongoing communications. Any number of audio, visual, or tactile alerts, indicators, or alarms utilized to indicate communications are sent, received, in transmission, being received, or so forth.

In one embodiment, the mesh network may be automatically created between wireless earpieces. For example, user preferences, settings, permissions, or other configuration information associated with each of the wireless earpieces may be utilized to establish and utilize the mesh network. The mesh network may also be created based on user input linking separate wireless earpieces, users, wireless devices, or other electronics. For example, the wireless earpieces may be linked utilizing one or more user names, pin numbers, passwords, network names, IMEIs, IP addresses, user biometrics, locations, events, environments, or other device/user identifiers.

In another embodiment, multiple wireless earpieces may be utilized to create a mesh network of sensors or sensor array. The wireless earpieces may be able to create a three-dimensional sound environment or re-creation. In other embodiments, additional sensors of the wireless earpieces may be utilized to create a visual, thermal, pressure, radiation, or other three-dimensional image, view, re-creation, visual, display, graphic, or other content. For example, the mesh network may also determine if users wearing wireless earpieces within a specified area or environment suddenly experience an increase in heart rate, blood pressure, temperature, or other user biometrics. The sensor array may be utilized for enhancing user experiences (e.g., entertainment, received content, etc.), safety, security, crowd control, and so forth.

The illustrative embodiments may allow wireless earpieces to utilize an extended range to perform communications through a mesh network. The mesh network may be created or utilized as needed with the individual wireless earpieces (or sets of wireless earpieces), wireless devices, or other electronics acting as nodes within the mesh network 100. The communications and sensor mesh networks may be utilized for any number of personal, commercial, organizational, military, and other purposes.

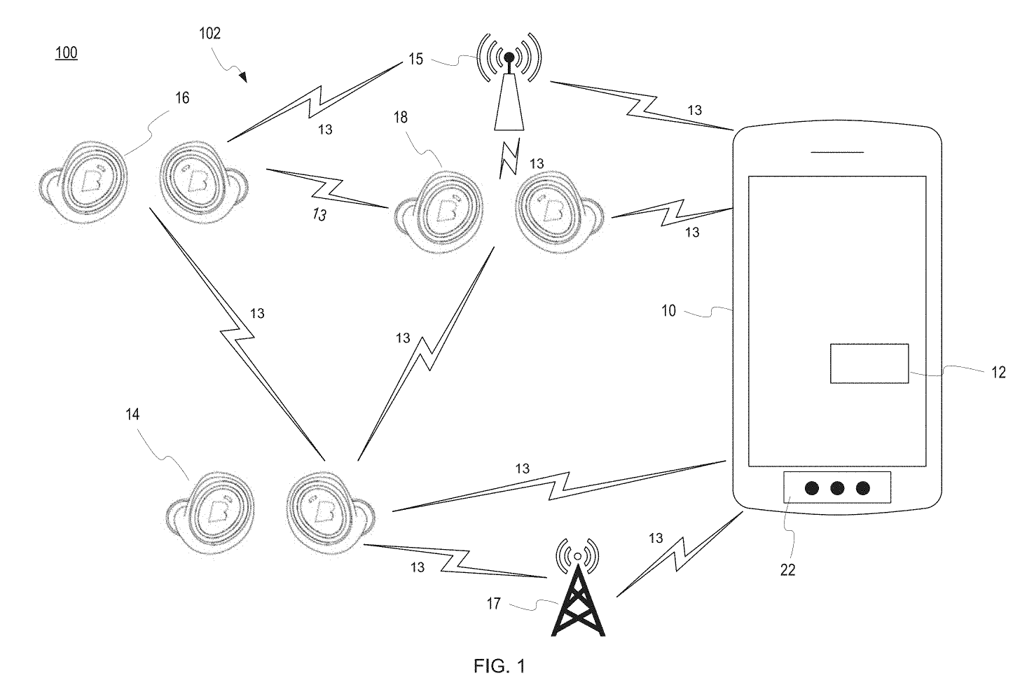

FIG. 1 illustrates a pictorial representation of a mesh network 100 in accordance with an illustrative embodiment. FIG. 1 illustrates a system 102 including an electronic device 10, a software application 12 executable on the electronic device 10, and wireless earpieces 14, 16, 18 worn by one or more users. The wireless earpieces 14, 16, 18 may reference a set of wireless earpieces, a left wireless earpiece, or a right wireless earpiece. Correspondingly, references herein to wireless earpieces or a wireless earpiece may refer to a set of wireless earpieces and/or an individual wireless earpiece. In one embodiment, the electronic device 10 may represent a mobile phone, a tablet, a laptop, a desktop computer, a wireless earpiece, a watch, or any other type of electronic device capable of both receiving a user input and interacting with outside electronic devices.

The software application 12 executable on the electronic device 10 may be either stored on the electronic device 10 or may be directly accessible from an outside or third party electronic device, such as a server, a communications tower, a portable memory device, or a computing device such a tablet, a desktop computer, or a laptop, and only a portion of the software application 12 may be executed on the electronic device 10 in order to function. The software application 12 may be programmed to transmit a communication request to one or more wireless earpieces 14 in response to an action taken by a user of the electronic device 10 to establish a connection. The software application 12 may represent a program, an operating system, a kernel, a module, a script, a set of instructions, or other software. The software application 12 may also be executed by the wireless earpieces 14, 16, 18. For example, software applications, logic, or hardware utilized by the wireless earpieces 14, 16, 18 and electronic device 10 to implement the illustrative embodiments.

A communication request may be directed to one or more wireless earpieces 14 or may be communicated through one or more intermediary electronic devices, such as a router, repeater, communications tower 15, wi-fi hot-spot 17 a satellite, a server, or another computing device capable of receiving radio frequency, electromagnetic, or other wireless signals before reaching a wireless earpiece 14. The communication request may be directed to additional wireless earpieces (e.g., wireless earpieces 16, 18) or even other types of electronic devices used, worn, or carried by a user or third parties.

In one embodiment, the connection to the electronic device 10 initiated by the software application 12 may be established in response to a gesture from a third party sensed by the wireless earpieces 14 associated with a user. For example, a communication or communication request may be received by the wireless earpieces 14, the wireless earpieces 14 may immediately communicate the communication to the wireless earpiece 16 in response to a link, signal, or communication being available. If the connection between the wireless earpieces 14 and the wireless earpieces 16 is not immediately available, the wireless earpieces 14 may wait until the wireless earpieces 16 are available to relay the communication. Similarly, the wireless earpieces 16 may send the communication (originally received from the wireless earpieces 14) to the wireless earpieces 18 once a connection is available. The wireless earpieces 18 may send the communication to the electronic device 10. The electronic device 10 may communicate with a wired or wireless network (e.g., Wi-Fi 17, cellular 15, etc.) to further communicate the original communication. The system 102 may also be referred to as a mesh network 100. In a mesh network 100, each of the nodes (e.g., wireless earpieces 14, 16, 18, electronic device 10, hot-spot 17, cell tower 15 etc.) may relay data or communications for the network 100. All mesh nodes cooperate in the distribution of data in the network 100. The system 102 may utilize a flooding technique or a routing technique. In a routing technique, the communication may be propagated along a path through wireless earpieces/electronic devices until the communication reaches the desired location. The communication hops from node to node being rerouted as needed to reach the destination. In a flooding technique, the communications are sent through every available connection or link (other than the one the communication came from) until the communication reaches the destination. Controlled or uncontrolled flooding may be utilized as part of the mesh network 100 of FIG. 1.

Although, examples of a path(s) 13 are shown in FIG. 1 between the wireless earpieces 14 and the electronic device 10. Any number of paths 13 may be established between the initial receiving device and the destination device. In addition, any number of additional devices may be added to or removed from the system 102 while still adapting and functioning as needed.

More than one user utilizing wireless earpieces may connect to the electronic device 10 beyond the wireless earpieces 18 as are shown in FIG. 1. The electronic device 10 may represent any number of mobile phones, tablets, laptops, desktop computers, smart glasses, smart jewelry, eyepieces, and watches.

Gestures may be used with the wireless earpiece 14, 16, 18 to receive a communication or communication information, establish a link, or otherwise provide feedback or input including head gestures, hand gestures, finger gestures, tapping gestures, swiping gestures, or any sort of tactile input or gesture may be sensed by the wireless earpiece 14, 16, 18 and more than one type of gesture may be used. In another embodiment, the wireless earpiece 14, 16, 18 may receive verbal or audio commands to implement an action. Visual, audio, or other media recorded or stored by a second electronic device, such as a smartphone, a camcorder, a digital camera, or electronic eyewear, operatively connected to one or more wireless earpieces 14, 16, 18 worn by one or more third parties, may be communicated by one or more third parties wearing the wireless earpieces 14 or the electronic device 10. The communications sent and received by the system 102 may include voice, text, alerts, packets, images, audio, biometrics, email, readings, or so forth whether measured by the wireless earpieces 14 or received from an associated user or connected device.

In one embodiment, the wireless earpieces 14 may be separated to perform communications with each other (e.g., a left wireless earpiece given to a first user and a right wireless earpiece given to a second user). The wireless earpieces 14 may communicate utilizing any number of standards, protocols, or signals. The utilization of the wireless earpieces 14 may allow a user to further expand the scope or reach of the mesh network 100 of the system 102 without additional devices being required or necessary. In one embodiment, the electronic device 10 may be utilized as a repeater, booster, node, ranger extender or intermediary for relaying communications between the wireless earpieces 14. The wireless earpieces 14 may be utilized for sporting events or competitions, work environments, team exercises, organizations, military units, emergency responders, and so forth.

In one embodiment, the software 12 may include a graphical user interface displayed by the electronic device 10. The graphical user interface may allow a user to select whether the wireless earpieces 12, 14, 16 (or associated wireless/electronic devices) participate in communications through the mesh network 100. The software 12 may enable different types of mesh network communications, queueing, user preferences, parameters, configurations, icons, alerts, or so forth. Input may be provided to the electronic device 10 utilizing any number of touch screens, buttons, knobs, scroll wheels, or so forth.

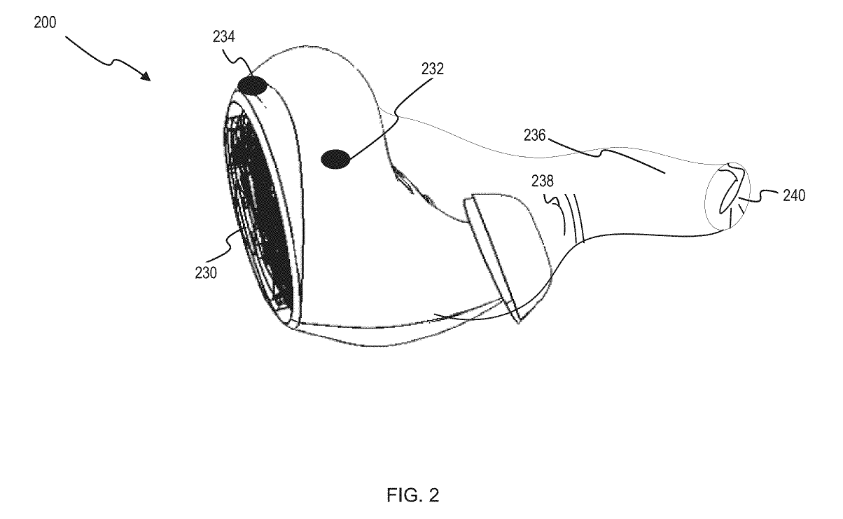

FIG. 2 illustrates a right wireless earpiece 200 of a wireless earpiece set as it relates to a user's right ear in accordance with an illustrative embodiment. The user may interact with the right wireless earpiece 200 by either providing a gesture sensed by a gesture interface 230, a voice command sensed via a microphone 232, or by one or more head or neck motions which may be sensed by an inertial sensor 234 such as a MEMS gyroscope, magnetometer, or an accelerometer. In one embodiment, the gesture interface 230 may include one or more optical sensors, touch/capacitive sensors, or so forth. The microphone 232 may represent one or more over-air or bone conduction microphones. The air-based microphone may be positioned on an exterior of the right wireless earpiece 200 when worn by the user. The bone conduction microphone may be positioned on an interior portion of the right wireless earpiece 200 to abut the skin, tissues, and bones of the user.

For example, if a user wearing the right wireless earpiece 200 wishes to transcribe and send a text message through the wireless earpiece the user may give a voice command to specify a recipient and the message to be communicated utilizing the microphone 232, once read back or verified, the user may nod his head, which may be sensed by the inertial sensor 234 such as an accelerometer via voltage changes due to capacitance differentials caused by the nodding of the head to send the text message through a mesh network. In addition, the user may tap on or swipe across the gesture interface 230 to bring up a menu in which to send, for example, a preprogrammed reply or one or more pieces of media the third party wishes to share with the user and/or one or more other third parties currently connected to the third party.

The user may also wish to control which parties receive a communication or transmission by accessing a second menu via an additional gesture, such as a voice command or a finger swipe, to determine which parties receive the communication. As noted, voice communications, commands, or audio content to be transcribed may be received via the microphone 232. The right wireless earpiece 200 may be positioned within the ear canal 236 to minimize the distance between the right wireless earpiece 200 and the user's tympanic membrane 240 so any sound communications 238 received by the third party are effectively communicated to the third party using the right wireless earpiece 200.

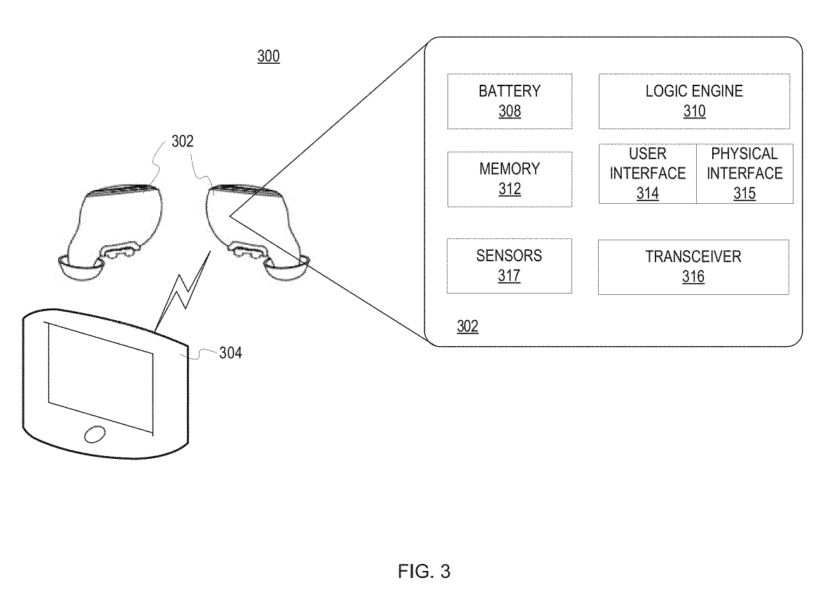

FIG. 3 is a block diagram of a wireless earpiece system 300 in accordance with an illustrative embodiment. As previously noted, the wireless earpieces 302 may be referred to or described herein as a pair (wireless earpieces) or singularly (wireless earpiece). The description may also refer to components and functionality of each of the wireless earpieces 302 collectively or individually. In one embodiment, the wireless earpiece system 300 may enhance communications and functionality of the wireless earpieces 302. In one embodiment, the wireless earpiece system 300 or wireless earpieces 302 may be part of a mesh network (e.g., send device, receiving device, node in the mesh network, etc.).

As shown, the wireless earpieces 302 may be wirelessly linked to the wireless device 304. For example, the wireless device 304 may represent a smart phone. The wireless device 304 may also represent a gaming device, tablet computer, vehicle system (e.g., GPS, speedometer, pedometer, entertainment system, etc.), media device, smart watch, laptop, smart glass, or other electronic devices. User input, commands, and communications may be received from either the wireless earpieces 302 or the wireless device 304 for implementation on either of the devices of the wireless earpiece system 300 (or other externally connected devices).

In some embodiments, the wireless device 304 may act as a logging tool for receiving information, data, or measurements made by the wireless earpieces 302. For example, the wireless device 304 may download data from the wireless earpieces 302 in real-time. As a result, the wireless device 304 may be utilized to store, display, and synchronize data for the wireless earpieces 302 as well as manage communications. For example, the wireless device 304 may display pulse, proximity, location, oxygenation, distance, calories burned, and so forth as measured by the wireless earpieces 302. The wireless device 304 may be configured to receive and display an interface, selection elements, and alerts indicate conditions to implement mesh communications. For example, the wireless earpieces 302 may utilize factors, such as changes in motion or light, distance thresholds between the wireless earpieces 302 and/or wireless device 304, signal activity, user orientation, user speed, user location, environmental factors (e.g., temperature, humidity, noise levels, proximity to other users, etc.) or other automatically determined or user specified measurements, factors, conditions, or parameters to implement various features, functions, and commands.

The wireless device 304 may also include any number of optical sensors, touch sensors, microphones, and other measurement devices may provide feedback or measurements the wireless earpieces 302 may utilize to determine an appropriate mode, settings, or enabled functionality. The wireless earpieces 302 and the wireless device 304 may have any number of electrical configurations, shapes, and colors and may include various circuitry, connections, and other components.

In one embodiment, the wireless earpieces 302 may include a battery 308, a logic engine 310, a memory 312, a user interface 314, a physical interface 315, a transceiver 316, and sensors 317. The wireless device 304 may have any number of configurations and include components and features like the wireless earpieces 302 as are known in the art. The mesh functionality and logic may be implemented as part of the logic engine 310, user interface, or other hardware, software, or firmware of the wireless earpieces and/or wireless device 304.

The battery 308 is a power storage device configured to power the wireless earpieces 302. In other embodiments, the battery 308 may represent a fuel cell, thermal electric generator, piezo electric charger, solar charger, ultra-capacitor, or other existing or developing power storage technologies. The logic engine 310 preserves the capacity of the battery 308 by reducing unnecessary utilization of the wireless earpieces 302 in a full-power mode when there is little or no benefit to the user (e.g., the wireless earpieces 302 are sitting on a table or temporarily lost). The battery 308 or power of the wireless earpieces are preserved for when being worn or operated by the user. As a result, user satisfaction with the wireless earpieces 302 is improved and the user may be able to set the wireless earpieces 302 aside at any moment knowing battery life is automatically preserved by the logic engine 310 and functionality of the wireless earpieces 302. In addition, the battery 308 may use very little power when additional wireless earpieces or devices (nodes) are not available to limit unnecessary power utilization. Likewise, the power output may be increased when mesh communications or nodes are available.

The logic engine 310 is the logic controlling the operation and functionality of the wireless earpieces 302. The logic engine 310 may include circuitry, chips, and other digital logic. The logic engine 310 may also include programs, scripts, and instructions implemented to operate the logic engine 310. The logic engine 310 may represent hardware, software, firmware, or any combination thereof. In one embodiment, the logic engine 310 may include one or more processors. The logic engine 310 may also represent an application specific integrated circuit (ASIC) or field programmable gate array (FPGA). In one embodiment, the logic engine 310 may execute instructions to manage a virtual assistant (e.g., Siri, Google Home, Alexa) including interactions with the components of the wireless earpieces 302, such as the user interface 314 and sensors 317.

The logic engine 310 may utilize measurements from two or more of the sensors 317 to determine whether mesh communications are being requested or otherwise needed. The logic engine 310 may control actions implemented in response to any number of measurements from the sensors 317, the transceiver 316, the user interface 314, or the physical interface 315 as well as user preferences 320 the user entered or other default preferences. For example, the logic engine 310 may initialize or otherwise use mesh communications in response to any number of factors, conditions, parameters, measurements, data, values, or other information specified within the logic engine 310 or by the user preferences 320. For example, mesh communications may be utilized in response to determining a traditional Wi-Fi, cellular, or other connection or signal is not available. Mesh networks may also be utilized in response to determining traditional communications processes, methodologies, or so forth are unavailable.

The logic engine 310 may implement any number of processes for the wireless earpieces 302, such as facilitating communications, listening to music, tracking biometrics or so forth. The wireless earpieces 302 may be configured to work together or completely independently based on the needs of the user. For example, the wireless earpieces 302 may be used by two different users at one time.

The logic engine 310 may also process user input to determine commands implemented by the wireless earpieces 302 or sent to the wireless device 304 through the transceiver 316. Specific actions may be associated with user input (e.g., voice, tactile, orientation, motion, gesture, etc.). For example, the logic engine 310 may implement a macro allowing the user to associate frequently performed actions with specific commands/input implemented by the wireless earpieces 302.

In one embodiment, a processor included in the logic engine 310 is circuitry or logic enabled to control execution of a set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks.

The memory 312 is a hardware element, device, or recording media configured to store data or instructions for subsequent retrieval or access later. The memory 312 may represent static or dynamic memory. The memory 312 may include a hard disk, random access memory, cache, removable media drive, mass storage, or configuration suitable as storage for data, instructions, and information. In one embodiment, the memory 312 and the logic engine 310 may be integrated. The memory 312 may use any type of volatile or non-volatile storage techniques and mediums. The memory 312 may store information related to the status of a user, wireless earpieces 302, wireless device 304, and other peripherals, such as a tablet, smart glasses, a smart watch, a smart case for the wireless earpieces 302, a wearable device, and so forth. In one embodiment, the memory 312 may display instructions, programs, drivers, or an operating system for controlling the user interface 314 including one or more LEDs or other light emitting components, speakers, tactile generators (e.g., vibrator), and so forth. The memory 312 may also store thresholds, conditions, signal or processing activity, proximity data, and so forth.

The transceiver 316 is a component comprising both a transmitter and receiver which may be combined and share common circuitry on a single housing. The transceiver 316 may communicate utilizing Bluetooth, Wi-Fi, ZigBee, Ant+, near field communications, wireless USB, infrared, mobile body area networks, ultra-wideband communications, cellular (e.g., 3G, 4G, 5G, PCS, GSM, etc.), infrared, or other suitable radio frequency standards, networks, protocols, or communications. The transceiver 316 may also be a hybrid or multi-mode transceiver supporting several different communications. For example, the transceiver 316 may communicate with the wireless device 304 or other systems utilizing wired interfaces (e.g., wires, traces, etc.), NFC, or Bluetooth communications as well as with the other wireless earpiece utilizing NFMI. The transceiver 316 may also detect amplitudes and signal strength to infer distance between the wireless earpieces 302 as well as the wireless device 304.

The components of the wireless earpieces 302 may be electrically connected utilizing any number of wires, contact points, leads, busses, wireless interfaces, or so forth. In addition, the wireless earpieces 302 may include any number of computing and communications components, devices or elements which may include busses, motherboards, printed circuit boards, circuits, chips, sensors, ports, interfaces, cards, converters, adapters, connections, transceivers, displays, antennas, and other similar components. The physical interface 315 is a hardware interface of the wireless earpieces 302 for connecting and communicating with the wireless device 304 or other electrical components, devices, or systems.

The physical interface 315 may include any number of pins, arms, or connectors for electrically interfacing with the contacts or other interface components of external devices or other charging or synchronization devices. For example, the physical interface 315 may be a micro USB port. In one embodiment, the physical interface 315 is a magnetic interface automatically coupling to contacts or an interface of the wireless device 304. In another embodiment, the physical interface 315 may include a wireless inductor for charging the wireless earpieces 302 without a physical connection to a charging device. The physical interface 315 may allow the wireless earpieces 302 to be utilized when not worn as a remote microphone and sensor system (e.g., seismometer, thermometer, light detection unit, motion detector, etc.). For example, measurements, such as noise levels, temperature, movement, and so forth may be detected by the wireless earpieces even when not worn. The wireless earpieces 302 may be utilized as a pair, independently, or when stored in a smart case. Each of the wireless earpieces 302 may provide distinct sensor measurements as needed. In one embodiment, the smart case may include hardware (e.g., logic, battery, transceiver, etc.) to integrate as part of a mesh network. For example, the smart case may be utilized as a node or relay within a mesh network for sending and receiving communications.

The user interface 314 is a hardware interface for receiving commands, instructions, or input through the touch (haptics) of the user, voice commands, or predefined motions. The user interface 314 may further include any number of software and firmware components for interfacing with the user. The user interface 314 may be utilized to manage and otherwise control the other functions of the wireless earpieces 302 including mesh communications. The user interface 314 may include the LED array, one or more touch sensitive buttons or portions, a miniature screen or display, or other input/output components (e.g., the user interface 314 may interact with the sensors 317 extensively). The user interface 314 may be controlled by the user or based on commands received from the wireless device 304 or a linked wireless device. In one embodiment, mesh communications may be controlled by the user interface, such as recording communications, receiving user input for communications, queuing communications, sending communications, receiving user preferences for the communications, and so forth. The user interface 314 may also include a virtual assistant for managing the features, functions, and components of the wireless earpieces 302.

In one embodiment, the user may provide user input for the user interface 314 by tapping a touch screen or capacitive sensor once, twice, three times, or any number of times. Similarly, a swiping motion may be utilized across or in front of the user interface 314 (e.g., the exterior surface of the wireless earpieces 302) to implement a predefined action. Swiping motions in any number of directions or gestures may be associated with specific activities or actions, such as play music, pause, fast forward, rewind, activate a virtual assistant, listen for commands, report biometrics, enabled mesh communications, and so forth.

The swiping motions may also be utilized to control actions and functionality of the wireless device 304 or other external devices (e.g., smart television, camera array, smart watch, etc.). The user may also provide user input by moving his head in a direction or motion or based on the user's position or location. For example, the user may utilize voice commands, head gestures, or touch commands to change the processes implemented by the wireless earpieces 302 as well as the processes executed, or content displayed by the wireless device 304. The user interface 314 may also provide a software interface including any number of icons, soft buttons, windows, links, graphical display elements, and so forth.

In one embodiment, the sensors 317 may be integrated with the user interface 314 to detect or measure the user input. For example, infrared sensors positioned against an outer surface of the wireless earpieces 302 may detect touches, gestures, or other input as part of a touch or gesture sensitive portion of the user interface 314. The outer or exterior surface of the user interface 314 may correspond to a portion of the wireless earpieces 302 accessible to the user when the wireless earpieces are worn within the ears of the user.

In addition, the sensors 317 may include pulse oximeters, accelerometers, thermometers, barometers, radiation detectors, gyroscopes, magnetometers, global positioning systems, beacon detectors, inertial sensors, photo detectors, miniature cameras, and other similar instruments for detecting user biometrics, environmental conditions, location, utilization, orientation, motion, and so forth. The sensors 317 may provide measurements or data utilized to select, activate, or otherwise utilize the mesh network. Likewise, the sensors 317 may be utilized to awake, activate, initiate, or otherwise implement actions and processes utilizing conditions, parameters, values, or other data within the user preferences. For example, the optical biosensors within the sensors 317 may determine whether the wireless earpieces 302 are being worn and when a selected gesture to activate the virtual assistant is provided by the user.

The wireless device 304 may include components similar in structure and functionality to those shown for the wireless earpieces 302. The computing device may include any number of processors, batteries, memories, busses, motherboards, chips, transceivers, peripherals, sensors, displays, cards, ports, adapters, interconnects, and so forth. In one embodiment, the wireless device 304 may include one or more processors and memories for storing instructions. The instructions may be executed as part of an operating system, application, browser, or so forth to implement the features herein described. In one embodiment, the wireless earpieces 302 may be magnetically, wirelessly, or physically coupled to the wireless device 304 to be recharged or synchronized or to be stored. In one embodiment, the wireless device 304 may include applications compatible and enabling mesh network communications. As a result, the separate instances may function as a single application to enhance functionality. The wireless earpieces 302 and wireless device 304 may utilize any number of mesh networks including standards, protocols, devices, and so forth.

The wireless device 304 may be utilized to adjust the user preferences including settings, thresholds, activities, conditions, environmental factors, and so forth utilized by the wireless earpieces 302 and the wireless device 304. For example, the wireless device 304 may utilize a graphical user interface allowing the user to more easily specify any number of conditions, values, measurements, parameters, and factors utilized to perform communications through the mesh network.

In another embodiment, the wireless device 304 may also include sensors for detecting the location, orientation, and proximity of the wireless earpieces 302 to the wireless device 304. The wireless earpieces 302 may turn off communications to the wireless device 304 in response to losing a status or heart beat connection to preserve battery life and may only periodically search for a connection, link, or signal to the wireless device 304. The wireless earpieces 302 may also turn off components, enter a low power or sleep mode, or otherwise preserve battery life in response to no interaction with the user for a period, no detection of the presence of the user (e.g., touch, light, conductivity, motion, etc.), or so forth.

As originally packaged, the wireless earpieces 302 and the wireless device 304 may include peripheral devices such as charging cords, power adapters, inductive charging adapters, solar cells, batteries, lanyards, additional light arrays, speakers, smart case covers, transceivers (e.g., Wi-Fi, cellular, etc.), or so forth. In one embodiment, the wireless earpieces 302 may include a smart case (not shown). The smart case may include an interface for charging the wireless earpieces 302 from an internal battery as well as through a plugged connection. The smart case may also utilize the interface or a wireless transceiver to log utilization, biometric information of the user, and other information and data. The smart case may also be utilized as a repeater as part of the mesh network (e.g., a node in the mesh network), a signal amplifier, relay, or so forth.

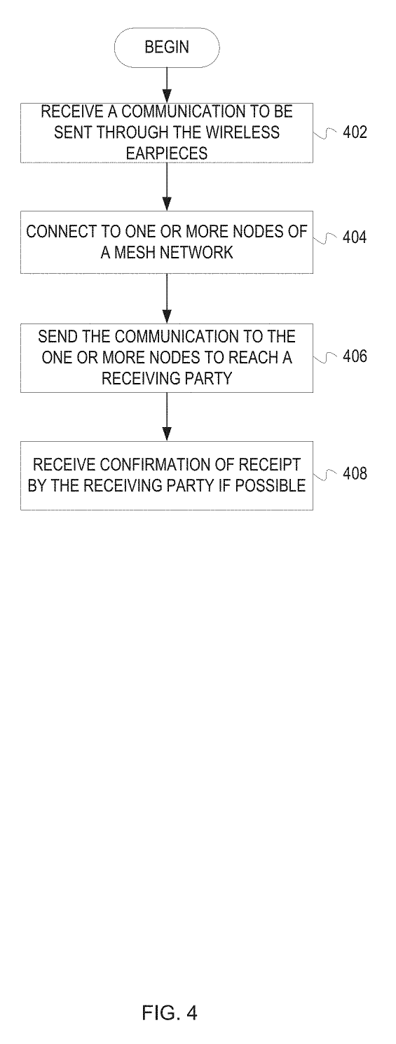

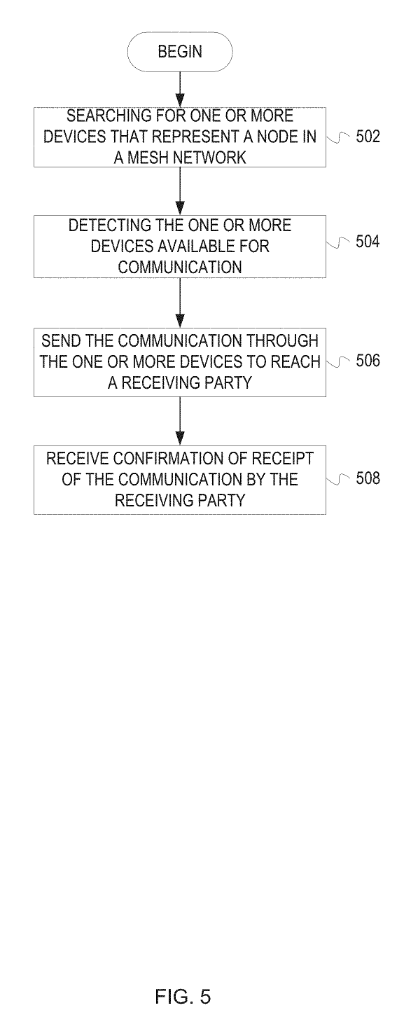

FIG. 4 is a flowchart of a process for performing communications through a mesh network utilizing wireless earpieces in accordance with an illustrative embodiment. The process of FIGS. 4 and 5 may be implemented by several wireless earpieces (sets or individual wireless earpieces), wireless devices, wired devices, or so forth. The individual devices may represent nodes in the mesh network. In one embodiment, the processes of FIGS. 4 and 5 may be implemented in response to determining traditional communications are not available (e.g., Bluetooth, Wi-Fi, cellular communications through a connected wireless device, etc.). The method of FIG. 4 may be implemented by one wireless earpiece, a set of wireless earpieces, or wireless earpieces associated with a wireless device.

The process of FIG. 4 may begin by receiving a communication to be sent through the wireless earpieces (step 402). The communications may represent audio, video, text, or tactile input or messages. The communications may represent direct or indirect communications received from the user as well as discrete, real-time, or ongoing communications. In one embodiment, the communication may represent one or several different communications sent to one or more recipient users or devices. For example, the communication may represent audio content transcribed by the wireless earpieces for communication as a text message. In another example, the audio content of the message may be sent as an audio file. In another example, the communication may represent a detected biometric event, such as an impact beyond a specified threshold, rapid drop or increase in user vitals, or other biometric or environmental conditions, parameter, event, or so forth.

Next, the wireless earpieces connect to one or more nodes of a mesh network (step 404).

The process of step 404 may involve searching for or detecting one or more available nodes. The wireless earpieces may connect to a single node, multiple nodes, dedicated nodes, or so forth. The wireless earpieces may connect through a signal, link, or connection.

Next, the wireless earpieces send the communication to the one or more nodes to reach a receiving party (step 406). The communications may be sent by the originating wireless earpieces without a dedicated or fixed connection. In one embodiment, the communication may represent an emergency message generally broadcast to any potential “listening” devices for relaying or subsequent communication through the mesh network. During step 406, the communication may be sent to a single available node or to several available nodes depending on the type of mesh network communications being utilized (e.g., flooding, routing, etc.). For example, the communication may be communicated from node to node in the mesh network until the communication reaches the receiving party (e.g., destination device, desired user, target, etc.). The receiving party may represent one or more intended recipients. In another example, the communications may be sent utilizing a flooding technique through all available connections (except a connection the communication arrived from). The mesh network may utilize any number of bridging methodologies, systems, protocols, and so forth, such as open shortest path first (OSPF), distance vector multicast routing protocol (DVMRP), peer-to-peer sharing, sequence number-controlled flooding (SNCF), reverse path flooding (RPF), self-healing for routes, and so forth. The mesh network may represent any number of network topologies utilized for communication. For example, the mesh network may represent an ad-hoc network or other combinations of standard or developing networks (e.g., cellular, Wi-Fi, home communication, satellite, wireless, drone, powerline, etc.).

FIG. 5 is a flowchart of another process for performing communications through a mesh network utilizing wireless earpieces in accordance with an illustrative embodiment. The process of FIG. 5 may be performed as part of the process of FIG. 4 or as a separate process.

The process may begin by searching for one or more devices representing a node in a mesh network (step 502). The wireless earpieces or the associated wireless device may receive and process available signals, send pings, handshakes, or other communications, or otherwise search for one or more available nodes. The wireless earpiece (or an associated wireless device) may search utilizing one or more available transceivers, standards, protocols, or signals.

Next, the wireless earpieces detect the one or more devices available for communication (step 504). The one or more devices may represent nodes in the mesh network or the receiving party itself. The wireless earpieces may detect a signal, link, connection, packet, or other communication or indicator. In other examples, the wireless device(s) associated with the wireless earpieces may detect the one or more devices. The available devices may be able to communicate with the wireless earpieces utilizing one or more of the available transceivers of the wireless earpieces or wireless devices associated with the wireless earpieces.

Next, the wireless earpieces send the communication through the one or more devices to reach a receiving party (step 506). In one embodiment, the communication may not be sent until the one or more devices are detected in step 504. For example, a communication may be queued or stored by the wireless earpieces until the one or more devices become available for mesh communications. Similarly, the storage or queuing process may be repeated by any of the devices within the mesh network. Messages may be sent through any number of devices to ensure a message is received. For example, all or portions of packets making up a communication may be duplicative and sent through different nodes with the duplicates being discarded or ignored by the receiving device when formatting and reassembling the message. Any number of security processes, methodologies, or so forth may be utilized by the wireless earpieces (e.g., encryption, password-protection, device identification, etc.).

Next, the wireless earpieces receive confirmation of receipt of the communication by the receiving party (step 508). The confirmation may be a delivery receipt, indicator, alert, marker, or other information actively delivered to the user or passively recorded or logged for subsequent review. The confirmation of receipt may be provided to the user of the wireless earpieces if the communication is delivered as specified by the user. In some embodiments, the user may specify alternative communications devices, addresses, or routing for problematic communications (e.g., alternative email addresses, phone numbers, device identifiers, alternative recipients, emergency service personnel, etc.). In some embodiments, the user may select not to receive a delivery confirmation.

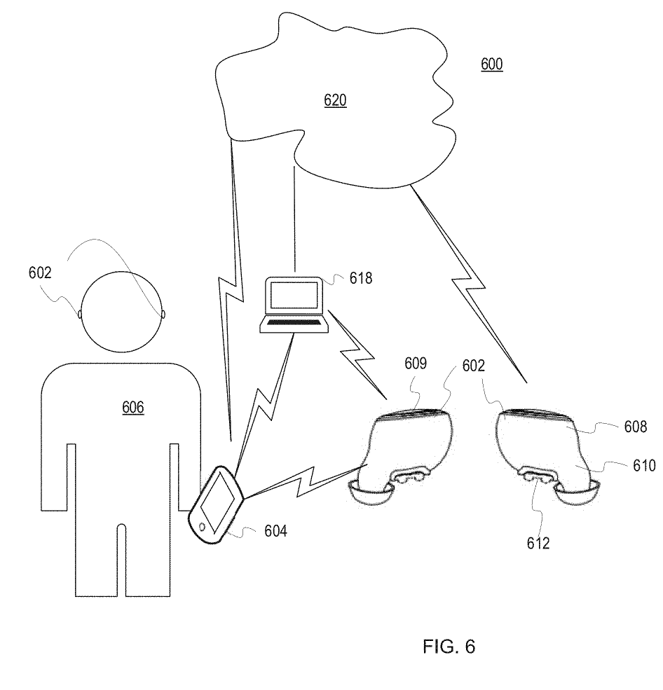

FIG. 6 is a pictorial representation of a communications environment 600 in accordance with an illustrative embodiment. The wireless earpieces 602 may be configured to communicate with each other and with one or more wireless devices, such as a wireless device 604 or a personal computer 618 (as well as the associated software including operating systems, kernels, applications, and so forth). The wireless earpieces 602 may be worn by a user 606 and are shown both as worn and separately from their positioning within the ears of the user 606 for purposes of visualization.

In one embodiment, the wireless earpieces 602 includes a housing 608 shaped to fit substantially within the ears of the user 606. The housing 608 is a support structure at least partially enclosing and housing the electronic components of the wireless earpieces 602. The housing 608 may be composed of a single structure or multiple interconnected structures (e.g., sonic welding, tape, interference fit, etc.). An exterior portion of the wireless earpieces 602 may include a first set of sensors shown as infrared sensors 609. The infrared sensors 609 may include emitter and receivers detecting and measuring infrared light radiating from objects within its field of view. The infrared sensors 609 may detect gestures, touches, or other user input against an exterior portion of the wireless earpieces 602 visible when worn by the user 606. The infrared sensors 609 may also detect infrared light or motion. The infrared sensors 609 may be utilized to determine whether the wireless earpieces 602 are being worn, moved, approached by a user, set aside, stored in a smart case, placed in a dark environment, or so forth. In one embodiment, the user 606 may configure the wireless earpieces 602 for usage even when not worn, such as when placed on a desk or table or positioned within a smart case charging, securing, and protecting the wireless earpieces 602 when not in use.

The housing 608 defines an extension 610 configured to fit substantially within the ear of the user 606. The extension 610 may include one or more speakers or vibration components for interacting with the user 606. The extension 610 may be removably covered by one or more sleeves. The sleeves may be changed to fit the size and shape of the user's ears. The sleeves may come in various interchangeable sizes and may have extremely tight tolerances to fit the user 606 and one or more additional users may utilize the wireless earpieces 602 during their expected lifecycle. In another embodiment, the sleeves may be custom built to support the interference fit utilized by the wireless earpieces 602 while also being comfortable while worn. The sleeves are shaped and configured to not cover various sensor devices of the wireless earpieces 602 or to allow operation through the sleeves where necessary. In other embodiments, the wireless earpieces 602 may be docked with other devices utilized or worn by the user 606, such as watches, glasses, headsets, jewelry, smart phones, personal computers, gaming devices, or so forth.

As previously noted, the housing 608 or the extension 610 (or other portions of the wireless earpieces 602) may include sensors 612 for sensing pulse, blood oxygenation, temperature, voice characteristics, skin conduction, glucose levels, impacts, activity level, position, location, orientation, as well as any number of internal or external user biometrics. In other embodiments, the sensors 612 may be positioned to contact or be proximate the epithelium of the external auditory canal or auricular region of the user's ears when worn. For example, the sensors 612 may represent various metallic sensor contacts, optical interfaces, or even micro-delivery systems for receiving, measuring, and delivering information and signals. Small electrical charges or spectroscopy emissions (e.g., various light wavelengths) may be utilized by the sensors 612 to analyze the biometrics of the user 606 including pulse, blood pressure, skin conductivity, blood analysis, sweat levels, and so forth. In one embodiment, the sensors 612 may include optical sensors emitting and measuring reflected light within the ears of the user 606 to measure any number of biometrics. The optical sensors may also be utilized as a second set of sensors to determine when the wireless earpieces 602 are in use, stored, charging, or otherwise positioned. The sensors 612 may include an array of components.

The sensors 612 may be utilized to provide relevant information communicated through the communications engine. As described, the sensors 612 may include one or more microphones integrated with the housing 608 or the extension of the wireless earpieces 602. For example, an external microphone may sense environmental noises as well as the user's voice as communicated through the air of the communications environment 600. The external microphones may sense additional user's voices to perform recordings, analysis, actions, or otherwise facilitate the activities of the user 606. An ear-bone or internal microphone may sense vibrations or sound waves communicated through the head of the user 602 (e.g., bone conduction, etc.).

In some applications, temporary adhesives or securing mechanisms (e.g., clamps, straps, lanyards, extenders, etc.) may be utilized to ensure the wireless earpieces 602 remain in the ears of the user 606 even during the most rigorous or physical activities or to ensure if they do fall out they are not lost or broken. For example, the wireless earpieces 602 may be utilized during marathons, swimming, team sports, biking, hiking, parachuting, or so forth. In one embodiment, miniature straps may attach to the wireless earpieces 602 with a clip on the strap securing the wireless earpieces to the clothes, hair, or body of the user. The wireless earpieces 602 may be configured to play music or audio, receive and make phone calls or other communications, determine ambient environmental conditions (e.g., temperature, altitude, location, speed, heading, etc.), read user biometrics (e.g., heart rate, motion, temperature, sleep, blood oxygenation, voice output, calories burned, forces experienced, etc.), and receive user input, feedback, or instructions. The wireless earpieces 602 may also execute any number of applications to perform specific purposes. The wireless earpieces 602 may be utilized with any number of automatic assistants, such as Siri, Cortana, Alexa, Google, Watson, or other smart assistants/artificial intelligence systems.

The communications environment 600 may further include the personal computer 618. The personal computer 618 may communicate with one or more wired or wireless networks, such as a network 620. The personal computer 618 may represent any number of devices, systems, equipment, or components, such as a laptop, server, tablet, transcription system, security system, gaming device, virtual/augmented reality system, or so forth. The personal computer 618 may communicate utilizing any number of standards, protocols, or processes. For example, the personal computer 618 may utilize a wired or wireless connection to communicate with the wireless earpieces 602, the wireless device 604, or other electronic devices. The personal computer 618 may utilize any number of memories or databases to store or synchronize biometric information associated with the user 606, data, passwords, or media content. The personal computer 618 may also include any number of databases. The wireless earpieces 602 may store all or portions of these databases, logic, services, and resources updated regularly as noted above.

The wireless earpieces 602 may determine their position with respect to each other as well as the wireless device 604 and the personal computer 618. For example, position information for the wireless earpieces 602 and the wireless device 604 may determine proximity of the devices in the communications environment 600. For example, global positioning information or signal strength/activity may be utilized to determine proximity and distance of the devices to each other in the communications environment 600. In one embodiment, the distance information may be utilized to determine whether biometric analysis may be displayed to a user. For example, the wireless earpieces 602 may be required to be within four feet of the wireless device 604 and the personal computer 618 to display biometric readings or receive user input. The transmission power or amplification of received signals may also be varied based on the proximity of the devices in the communications environment 600.

In one embodiment, the wireless earpieces 602 and the corresponding sensors 612 (whether internal or external) may be configured to take several measurements or log information and activities during normal usage. This information, data, values, and determinations may be reported to the user or otherwise utilized as part of the communications engine. The sensor measurements may be utilized to extrapolate other measurements, factors, or conditions applicable to the user 606 or the communications environment 600. For example, the sensors 612 may monitor the user's usage patterns or light sensed in the communications environment 600 to enter a full power mode in a timely manner. The user 606 or another party may configure the wireless earpieces 602 directly or through a connected device and app (e.g., mobile app with a graphical user interface) to set power settings (e.g., preferences, conditions, parameters, settings, factors, etc.) or to store or share biometric information, audio, and other data. In one embodiment, the user may establish the light conditions or motion may activate the full power mode or may keep the wireless earpieces 602 in a sleep or low power mode. As a result, the user 606 may configure the wireless earpieces 602 to maximize the battery life based on motion, lighting conditions, and other factors established for the user. For example, the user 606 may set the wireless earpieces 602 to enter a full power mode only if positioned within the ears of the user 606 within ten seconds of being moved, otherwise the wireless earpieces 602 remain in a low power mode to preserve battery life. This setting may be particularly useful if the wireless earpieces 602 are periodically moved or jostled without being inserted into the ears of the user 606. The wireless earpieces 602 may also be utilized to perform audio or light monitoring of a specified area.

The user 606 or another party may also utilize the wireless device 604 to associate user information and conditions with the user preferences. For example, an application executed by the wireless device 604 may be utilized to specify the conditions “waking up” the wireless earpieces 602 to automatically or manually communicate information, warnings, data, or status information to the user. In addition, the enabled functions (e.g., sensors, transceivers, vibration alerts, speakers, lights, etc.) may be selectively activated based on the user preferences as set by default, by the user, or based on historical information. In another embodiment, the wireless earpieces 602 may be adjusted or trained over time to become even more accurate in adjusting to communications needs, activities, habits, requirements, requests, activations, or other processes or functions performed by the communications engine. The wireless earpieces 602 may utilize historical information to generate default values, baselines, thresholds, policies, or settings for determining when and how the wireless earpieces 602 (or associated logic/applications) perform various communications, actions, and processes. As a result, the wireless earpieces 602 may effectively manage the automatic and manually performed processes of the wireless earpieces based on automatic detection of events and conditions (e.g., light, motion, user sensor readings, etc.) and user specified settings.

The wireless earpieces 602 may include any number of sensors 612 and logic for measuring and determining user biometrics, such as pulse rate, skin conduction, blood oxygenation, temperature, calories expended, blood or excretion chemistry, voice and audio output (e.g., stress level, amplitude, frequency, etc.), position, and orientation (e.g., body, head, etc.). The sensors 612 may also determine the user's location, position, velocity, impact levels, and so forth. Any of the sensors 612 may be utilized to detect or confirm light, motion, or other parameters affecting how the wireless earpieces 602 manage, utilize, and initialize the communications engine. The sensors 612 may also receive user input and convert the user input into commands or selections made across the personal devices of the personal area network. For example, the user input detected by the wireless earpieces 602 may include voice commands, head motions, finger taps, finger swipes, motions or gestures, or other user inputs sensed by the wireless earpieces. The user input may be determined by the wireless earpieces 602 and converted into authorization commands sent to one or more external devices, such as the wireless device 604, the personal computer 618, a tablet computer, or so forth. For example, the user 606 may create a specific head motion and voice command. When detected by the wireless earpieces 602 the command is utilized to send a request to the communications engine (implemented by the wireless earpiece or wireless earpieces 602/wireless device 604) to perform actions, such as perform mesh network communications, search for nodes, change verification settings, and so forth. Any number of actions may also be implemented by the communications engine in response to specified user input.

The sensors 612 may make all the measurements regarding the user 606 and communications environment 600 or may communicate with any number of other sensory devices, components, or systems in the communications environment 600. In one embodiment, the communications environment 600 may represent all or a portion of a personal area network. The wireless earpieces 602 may be utilized to control, communicate, manage, or interact with many other wearable devices or electronics, such as smart glasses, helmets, smart glass, watches or wrist bands, other wireless earpieces, chest straps, implants, displays, clothing, or so forth. The wireless earpieces 602 may also communicate with cameras, microphones, or other specialized or custom systems, equipment, components, software, or devices. A personal area network is a network for data transmissions among devices, components, equipment, and systems, such as personal computers, communications devices, cameras, vehicles, entertainment/media devices, and communications devices. The personal area network may interact as part of a mesh network and may utilize any number of wired, wireless, or hybrid configurations and may be stationary or dynamic. For example, the personal area network may utilize wireless network protocols or standards, such as INSTEON, IrDA, Wireless USB, Bluetooth, Z-Wave, ZigBee, Wi-Fi, ANT+ or other applicable radio frequency signals to communicate as part of a mesh network. In one embodiment, the personal area network may move with the user 606.

In other embodiments, the communications environment 600 may include any number of devices, components, or so forth communicating with each other directly or indirectly through a wireless (or wired) connection, signal, or link. The communications environment 600 may include one or more networks and network components and devices represented by the network 620, such as routers, servers, signal extenders, intelligent network devices, computing devices, or so forth. In one embodiment, the network 620 of the communications environment 600 represents a personal area network as previously disclosed. The wireless earpieces 602 may be utilized for walkie talkie type communications. Voice commands and input may be utilized to control the wireless earpieces 602 as well tactile or gesture-based input.

Communications within the communications environment 600 may occur through the network 620 or a Wi-Fi network or may occur directly between devices, such as the wireless earpieces 602 and the wireless device 604. In one embodiment, the network 620 represents a mesh network communicating with the wireless earpieces 602 as a set or individually, the wireless device 604, and the computing device 618 all of which may represent nodes of the network 620. The network 620 may communicate with, include, or access a wireless network, such as a Wi-Fi, cellular (e.g., 3G, 4G, 5G, PCS, GSM, etc.), Bluetooth, or other short range or long-range radio frequency networks, signals, connections, or links. The network 620 may also include or communicate with any number of hard wired networks, such as local area networks, coaxial networks, fiber-optic networks, network adapters, or so forth. Communications within the communications environment 600 may be operated by one or more users, service providers, or network providers.

The wireless earpieces 602 may play, display, communicate, or utilize any number of alerts or communications to indicate the actions, activities, communications, mode, or status used or being implemented by the wireless earpieces 602. For example, one or more alerts may indicate when additional wireless earpieces are within range of the wireless earpieces 602 utilizing specific tones, verbal acknowledgements, tactile feedback, or other forms of communicated messages. For example, an audible alert and LED flash may be utilized each time the wireless earpieces 602 send or receive communications to an intended recipient/receiving party. Verbal or audio acknowledgements, answers, and actions utilized by the wireless earpieces 602 are particularly effective because of user familiarity with such devices in standard smart phone and personal computers. The corresponding alert may also be communicated to the user 606, the wireless device 604, and the personal computer 618. In one embodiment, alerts or indicators may be utilized to indicate a message, information, or details available to a user. For example, an audible alert, such as a beep, and a tactile alert, such as a single vibration, may indicate the wireless earpieces are receiving a communication.

In other embodiments, the wireless earpieces 602 may also vibrate, flash, play a tone or other sound, or give other indications of the actions, status, or process of the communications. The wireless earpieces 602 may also communicate an alert to the wireless device 604 showing up as a notification, message, or other indicator indicating changes in status, actions, commands, or so forth.

The wireless earpieces 602 as well as the wireless device 604 may include logic for automatically implementing the communications logic in response to motion, light, audio, user activities, user biometric status, user location, user orientation/position, historical activity/requests, or various other conditions and factors of the communications environment 600. A communications engine may be activated to perform a specified activity or to “listen” or be prepared to “receive” user input, feedback, or commands for implementation by the wireless earpieces 602. The communications engine may also go into a recording or logging mode where all content or verbal communications are recorded for subsequent transcription, analysis, review, playback, or so forth.

The wireless device 604 may represent any number of wireless or wired electronic communications or computing devices, such as smart phones, laptops, desktop computers, control systems, tablets, transcription systems, security systems, displays, gaming devices, music players, personal digital assistants, vehicle systems, or so forth as well as the associated software (e.g., operating systems, kernels, applications, etc.). The wireless device 604 may communicate utilizing any number of wireless connections, standards, or protocols (e.g., near field communications, NFMI, Bluetooth, Wi-Fi, wireless Ethernet, etc.). For example, the wireless device 604 may be a touch screen cellular phone communicating with the wireless earpieces 602 utilizing Bluetooth communications. The wireless device 604 may implement and utilize any number of operating systems, kernels, instructions, or applications making use of the available sensor data sent from the wireless earpieces 602. For example, the wireless device 604 may represent any number of android, iOS, Windows, open platforms, or other systems and devices. Similarly, the wireless device 604 or the wireless earpieces 602 may execute any number of applications utilizing the user input, proximity data, biometric data, and other feedback from the wireless earpieces 602 to initiate, authorize, or process communications engine processes and perform the associated tasks. In one embodiment, the wireless earpieces 602 and the wireless device 604 may both execute communications engines operating independently or jointly to perform the processes herein described stored locally or accessed through the personal area network.

As noted, the layout of the internal components of the wireless earpieces 602 and the limited space available for a product of limited size may affect where the sensors 612 may be positioned. The positions of the sensors 612 within each of the wireless earpieces 602 may vary based on the model, version, and iteration of the wireless earpiece design and manufacturing process.

The illustrative embodiments may be utilized to perform communications utilizing a mesh network. The wireless earpieces may be utilized as the sending, receiving, or intermediary nodes of the mesh network. The communications sent may represent discrete, streaming, real-time, saved, or any number of other messages. The communications may be sent utilizing any number of standards, protocols, signals, or so forth. The mesh communications may be utilized for all communications, emergency communications, out-of-network communications, or so forth.

The illustrative embodiments may take the form of an entirely hardware embodiment, an entirely software embodiment (including firmware, resident software, micro-code, etc.) or an embodiment combining software and hardware aspects all generally referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, may include a machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or another communications medium.

Computer program code for carrying out operations of the embodiments may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

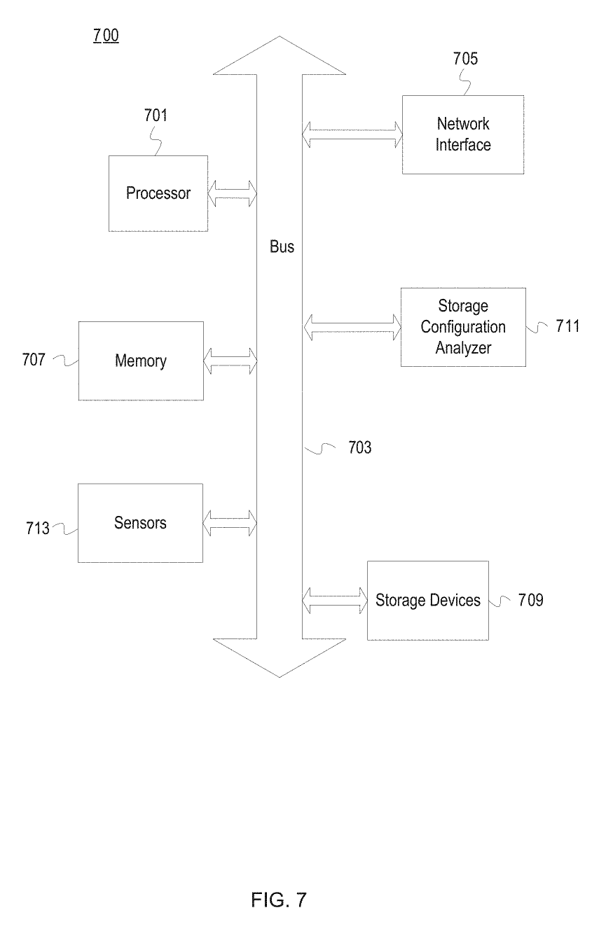

FIG. 7 depicts a computing system 700 in accordance with an illustrative embodiment. For example, the computing system 700 may represent a device, such as the wireless device 10 of FIG. 1. The computing system 700 includes a processor unit 701 (possibly including multiple processors, multiple cores, multiple nodes, and/or implementing multi-threading, etc.). The computing system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 703 (e.g., PCI, ISA, PCI-Express, HyperTransport®, InfiniBand®, NuBus, etc.), a network interface 706 (e.g., an ATM interface, an Ethernet interface, a Housing Relay interface, SONET interface, wireless interface, etc.), and a storage device(s) 709 (e.g., optical storage, magnetic storage, etc.).

The system memory 707 embodies functionality to implement all or portions of the embodiments described above. The system memory 707 may include one or more applications or sets of instructions for implementing a communications engine to communicate with one or more wireless earpieces and/or electronic devices in a mesh network. The communications engine may be stored in the system memory 707 and executed by the processor unit 702. As noted, the communications engine may be similar or distinct from a communications engine utilized by the wireless earpieces (e.g., a mesh communications application). Code may be implemented in any of the other devices of the computing system 700. Any one of these functionalities may be partially (or entirely) implemented in hardware and/or on the processing unit 701. For example, the functionality may be implemented with an application specific integrated circuit, in logic implemented in the processing unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701, the storage device(s) 709, and the network interface 705 are coupled to the bus 703. Although illustrated as being coupled to the bus 703, the memory 707 may be coupled to the processor unit 701. The computing system 700 may further include any number of sensors 713, such as optical sensors, accelerometers, magnetometers, microphones, gyroscopes, temperature sensors, and so forth for verifying user biometrics, or environmental conditions, such as motion, light, or other events may be associated with the wireless earpieces or their environment.

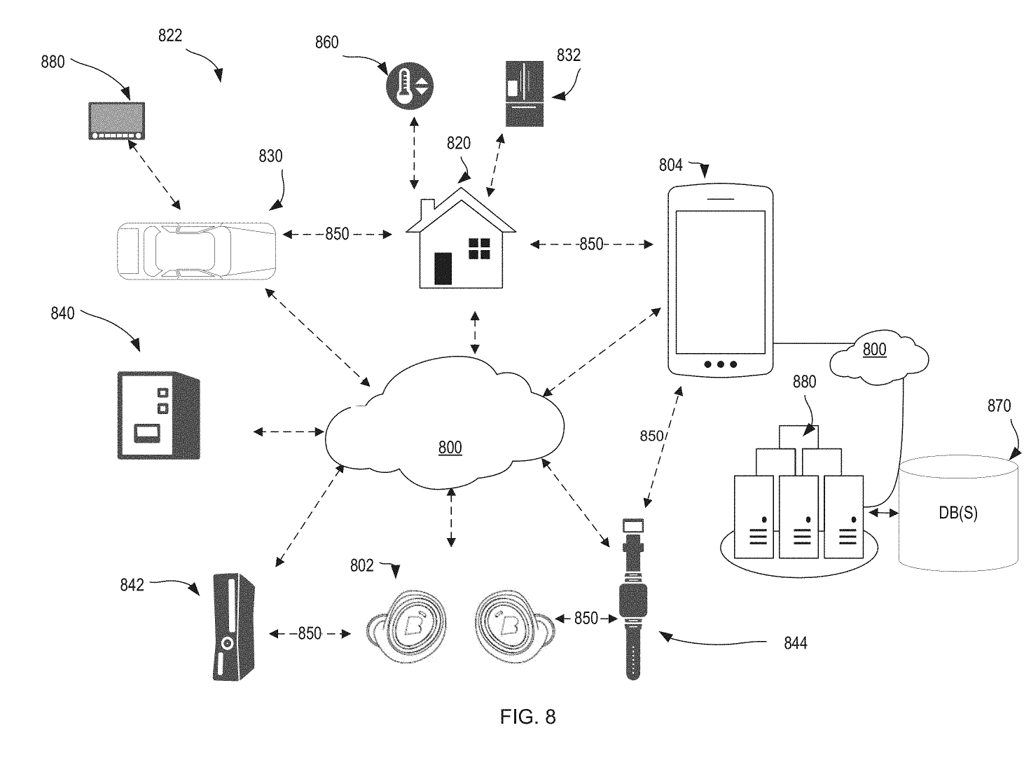

With reference to FIG. 8 a wireless earpiece with a mesh network for control of an Internet of Things (IoT) in an illustrative embodiment is shown. Bluetooth mesh networking, is a protocol based upon Bluetooth Low Energy (BLE) allowing for many-to-many communication over Bluetooth radio. It has been defined in Mesh Profile Specification and Mesh Model Specification. Communication is carried in messages up to 384 bytes long, when using a Segmentation and Reassembly (SAR) mechanism. However, most of the messages fit in one 11-byte segment. Each message starts with an opcode, which may be a single byte (for special messages), 2 bytes (for standard messages), or 3 bytes (for vendor-specific messages).

Every message has a source and a destination address, determining which devices process messages. Devices publish messages to destinations which can be single things/groups of things/everything. Each message has a sequence number protecting the network against replay attacks. Each message is encrypted and authenticated. Two keys are used to secure messages: (1) network keys—allocated to a single mesh network, (2) application keys—specific for a given application functionality (e.g. turning the light on vs reconfiguring the light). Messages have a time to live (TTL). Each time message is received and retransmitted, TTL is decremented which limits the number of “hops”, eliminating endless loops. Bluetooth Mesh is a flood network. It's based on the nodes relaying the messages: every relay node receiving a network packet authenticating against a known network key not in message cache, having a TTL≥2 can be retransmitted with TTL=TTL−1. Message cache used to prevent relaying messages recently seen.

Wireless earpieces 802 may also control peripheral devices through the BLE mesh IoT 822. BLE mesh IoT 822 is the network of physical devices, vehicles 830, home appliances 832 and other items embedded with electronics, software, sensors, actuators and network connectivity which enables these objects to connect and exchange data. Each peripheral device is uniquely identifiable through its embedded computing system but can inter-operate within the existing Internet infrastructure. The BLE mesh IoT 822 allows objects to be sensed or controlled remotely across existing network infrastructure 800, creating opportunities for more direct integration of the physical world into computer-based systems, and resulting in improved efficiency, accuracy and economic benefit in addition to reduced human intervention.

Peripheral devices in the BLE mesh IoT 822, can refer to a wide variety of devices such as vending machine 840, gaming system 842, smart watch 844, automobiles 830 with built-in sensors, smart home 820 or mobile device 804. These devices collect useful data with the help of various existing technologies and then autonomously flow the data between other devices.

Wireless earpieces 802, as discussed above, can link with a peripheral device within the BLE mesh IoT 822 as discussed above with reference to FIGS. 4 & 5. The peripheral devices shown in FIG. 8 can be a gaming system 842, smart watch 844, mobile device 804, smart home 820, vehicle 830 and a vending machine 840. These items are but a small list of the possible IoT devices. While only a handful of peripheral devices have been shown in the present application, it is fully contemplated most any device could be a peripheral device without departing from the spirit of the invention.

Wireless earpieces 802 can identify and couple with any identifiable peripheral device, either locally through BLE direct communications 850 or through an interne network 800. Once wireless earpieces 802 are paired with the peripheral devices, wireless earpieces 802 can control functionality and/or communicate with these peripheral devices. Furthermore, wireless earpieces 802 can be used to control other peripheral devices through the BLE mesh IoT 822.

A user could send voice instructions through the wireless earpieces 802 to smart home 820 to have HVAC system 860 turn the temperature down in smart home 820 and have smart home 820 find out from refrigerator 832 if any grocery shopping needed to be done. Smart home 820 would then send a message back to the wireless earpieces 802 informing the user the task was complete and providing a grocery list the user can store until they reach the supermarket. This application could also be performed with a smart assistant (e.g., Alexa®, Siri®, Google Home® and Cortana®) which speaks directly to the wireless earpieces 802 and allows the user to speak directly through a speaker coupled to the smart assistant to directly speak to the smart home 820 or to instruct the smart assistant to speak to or directly control the smart home 820.

A user can purchase a snack treat out of vending machine 840 through voice commands to wireless earpieces 802. The use can instruct what snack they would like, such as “A7” or “Nutter-Butter Bar”. When prompted by vending machine 840, wireless earpiece 802 could provide credit/debit information stored within memory 312 to vending machine 840.

A user could also instruct their gaming system 842 to begin downloading a game the user discovered while away from home. The user could use a voice command to the wireless earpieces 802 to give the instructions over network 800 of BLE mesh IoT 822 and gaming system 842 could begin the ordering and downloading of a game.

A user could also send a text via smart watch 844. A user could give an initial instruction to communicate with the smart watch, saying “Smart Watch” and then begin giving instructions to dictate and send a text. Or perhaps the user would like to know their biometric readings during their last workout or to have their biometric readings from their last workout stored on database 870 for storage and analysis. The user would simply instruct smart watch 844 through voice or any other type of command to wireless earpiece 802 to have the smart watch 844 perform these functions.

A user could also ask vehicle 830 what the mileage is on vehicle 830 and if vehicle 830 needs servicing. The user could also instruct vehicle 830 to have radio/navigation unit 880 to obtain directions for the user's next trip before the user gets to the vehicle. All through network 800 of BLE mesh IoT 822 controlled by wireless earpieces 802.

The wireless earpieces 802 may also utilize edge computing to make operation efficient and seamless. Edge computing is a method of optimizing cloud-computing systems by performing data processing at the edge of the network, near the source of the data. For purposes of the present invention, each peripheral such as mobile device 804, vehicle 830, smart home 820, smart watch 844, gaming system 842 and vending machine 840 (peripheral devices) all have the computing system 700 discussed thoroughly above. Because each peripheral device has a computing system data processing can be performed at each device, thus reducing the communications bandwidth needed between the peripheral devices and the central data center 880 by performing analytics and knowledge generation at or near the source of the data; the peripheral devices.

Edge computing pushes applications, data and computing power (services) away from centralized points to the logical extremes of a network. Edge computing replicates fragments of information across distributed networks of web servers, which may spread over a vast area. As a technological paradigm, edge computing is also referred to as mesh computing, peer-to-peer computing, autonomic (self-healing) computing, grid computing and by other names implying non-centralized, node-less availability.

The features, steps, and components of the illustrative embodiments may be combined in any number of ways and are not limited specifically to those described. The illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated other alternatives or exemplary aspects are considered included in the disclosure. The description is merely examples of embodiments, processes or methods of the invention. It is understood any other modifications, substitutions, and/or additions may be made, which are within the intended spirit and scope of the disclosure. For the foregoing, it can be seen the disclosure accomplishes at least all the intended objectives.

The previous detailed description is of a small number of embodiments for implementing the invention and is not intended to be limiting in scope. The following claims set forth several the embodiments of the invention disclosed with greater particularity.

What is claimed is:

1. The method of utilizing a mesh network utilizing wireless earpieces, comprising:
receiving a communication to be sent through the wireless earpieces;
connecting to one or more devices representing a node in a mesh network;
sending the communication to the one more devices to reach a receiving party through the mesh network; and
receiving a confirmation of receipt of the communication by the receiving party in response to the receiving party receiving the communication.

2. The method of claim 1, wherein the communication is an audio message received through one or more microphones of the wireless earpieces.

3. The method of claim 2, wherein the audio message is transcribed for the communication.

4. The method of claim 1, wherein sending the communication is repeated through a plurality of nodes of the mesh network to reach the receiving party.

5. The method of claim 4, wherein the plurality of nodes includes a plurality of wireless earpieces.

6. The method of claim 1, wherein the connecting further comprises:
searching for the one or more devices able to communicate as part of the mesh network; and
detecting the one or more devices.

7. The method of claim 1, wherein the sending is performed by a wireless device associated with the wireless earpieces.

8. The method of claim 1, further comprising:
receiving communications through the mesh network at the wireless earpieces from the one or more devices.

9. The method of claim 1, further comprising:
expanding the mesh network to include another device in response to the wireless earpieces or the one or more devices detecting another device is available for mesh communications.

10. The method of claim 1, wherein the communication includes real-time communications or discrete messages.

11. The method of claim 1, wherein the communication is saved by the wireless earpieces until the one or more devices of the mesh network are available for communicating the communications.

12. The method of claim 1, wherein the confirmation is an audible, visual, textual, or tactile input to the user utilizing the first wireless earpieces.

13. A wireless earpiece, comprising:
a housing for fitting in an ear of a user;
a logic engine controlling functionality of the wireless earpiece;
a plurality of sensors performing sensor measurements of the user and an environment of the user;
a transceiver searching for one or more devices able to communicate as part of a mesh network with the transceiver, and establishing a wireless connection between the transceiver and one of the one or more devices;
wherein the logic engine sends communications through the transceiver to the one or more devices available through the mesh network for communication to a receiving party.

14. The wireless earpiece of claim 13, wherein the communications are queued by the wireless earpiece until one of the one or more devices are available for mesh communications.

15. The wireless earpiece of claim 13, wherein the transceiver receives a confirmation the communications have been received by the receiving party.

16. The wireless earpiece of claim 13, wherein the communications are received audibly utilizing one or more microphones of the wireless earpiece for communication through the mesh network.

17. The wireless earpiece of claim 13, wherein the user is authenticated as having permission to send the communications utilizing biometrics measured by the sensor measurements.

18. A wireless earpiece, comprising:
a housing for fitting in an ear of a user;
a processor controlling functionality of the wireless earpiece;
a plurality of sensors read user input from the user;
a transceiver communicating with a mesh Internet of Things (IoT) network;
wherein the processor associates the wireless earpieces with the mesh IoT, receives user input from a user wearing the wireless earpieces, and sends a communication for a peripheral within the mesh IoT to perform the command from the wireless earpieces or from a second peripheral linked with the wireless earpieces.

19. The wireless earpiece of claim 10, wherein the processor verifies the user is authorized to utilize the peripheral.

20. The wireless earpiece of claim 10, wherein the peripheral performs data processing on an onboard computing system.
